(19) United States
(12) Patent Application Publication
(10) Pub. No.: US 2008/0083506 A1
(43) Pub. Date: Apr. 10, 2008

(54) Feeding mechanism for continuous processing of elongate base material, processing apparatus and thin film forming apparatus using the same, and elongate member produced thereby

(75) Inventors: Hideaki Awata, Itami-shi (JP); Katsuji Emura, Itami-shi (JP); Kentaro Yoshida, Itami-shi (JP); Nobuyuki Okuda, Itami-shi (JP); Jun Nakamura, Itami-shi (JP)

Correspondence Address: MCDERMOTT WILL & EMERY LLP, 600 13TH STREET, N.W., WASHINGTON, DC, 20005-3096, US

(73) Assignee: SUMITOMO ELECTRIC INDUSTRIES, LTD.

(21) Appl. No.: 11/797,950

(22) Filed: May 9, 2007

(30) Foreign Application Priority Data
Oct. 5, 2006 (JP) 2006-130923 (P)

(51) Int. Cl. B32B 37/00; B32B 7/02

(52) U.S. Cl. 156/582; 428/213

(57) ABSTRACT

A feeding mechanism, having a base station to which an elongate base material is continuously fed to be physically or chemically processed at a prescribed speed and from which the processed base material is continuously recovered, wherein tensile force T₁ in a direction opposite to a feeding direction is applied at a supply side of the base station, frictional force F is applied at the base station and tensile force T₂ in the feeding direction is applied at the recovery side of the base station, on said base material, with these forces satisfying the relation of F>T₁>T₂, is provided. A feeding mechanism for feeding a base material for performing physical or chemical processing with high accuracy while an elongate base material is continuously fed, particularly a feeding mechanism that suppresses thickness variation along the lengthwise direction or surface damage at a portion where a function is added of the processed base material, can be obtained.

### BACKGROUND OF THE INVENTION

1. Field of the Invention

The present invention relates to a mechanism for feeding a base material realizing highly accurate physical or chemical processing continuously on an elongate base material.

2. Description of the Background Art

A feeding mechanism for feeding elongate base materials of various cross-sectional shapes, provided with a base station for performing physical or chemical processing continuously at a prescribed speed, has been often used for providing a function of a prescribed standard over the entire length of the base materials. By way of example, the physical or chemical processing may include: quality alteration of base material surface by anodic oxidation of an aluminum-based material, or electron beam irradiation on chemical fiber; coating on the base material surface by forming a resin layer on a thin metal line, plating, formation of metal foil, or formation of a semiconductor layer or a magnetic layer on ceramics; and shaping such as drawing or fine fluting of metal lines. In such a feeding mechanism, it is necessary at least at the base station to keep constant the speed of passage of the base material. Therefore, it is necessary to apply appropriate tension to the base material before and after it passes through the base station, and to feed the base material along the same path over the entire length.

It is noted that when the base material is soft material such as resin, copper or aluminum, fragile material such as ceramics or paper, or thin or fine material having small cross-sectional area, for example, the base material tends to deform by environmental influence such as external force or heat while it is fed. Further, the base material is prone to damage as it slides over and gets stuck on a roller or other member, or it stretches and slips. Therefore, in order to ensure dimensional accuracy over the entire length of the processed portion of such a base material, it is necessary to feed at a constant speed and to apply tension appropriate for the material, at portions upstream and downstream of the base station.

It is particularly difficult to adjust the balance of feeding tension when a thin layer is to be formed with high dimensional accuracy on a surface of an elongate base material in the form of a tape or fiber. A so-called winding type thin film forming apparatus, in which an elongate strip-shaped material (hereinafter simply referred to as a tape) is fed to a thin film forming chamber and the film is continuously formed on the base material, is widely used for manufacturing various tapes including tapes for magnetic recording, printers and wrapping. Typically, a tape is fed using rollers provided at a supply portion, a cooling portion also serving as a base station, and a take-up portion on the side of recovering the processed base material, while the tape is kept in touch with a constant tension on the surfaces of these rollers. Conventionally, there have been problems of the degree of close contact between the tape and rollers, unevenness in film thickness resulting from fluctuation in feeding speed and damage to the film surface, and measures to avoid such problems have been considered. In the following, the background of the invention will be described with reference to the thin film forming apparatus as an example.

Japanese Patent Laying-Open No. 62-247073 proposes a mechanism that has a speed-variable sub-roller at least on one of the tape feed side and tape delivery side of the cooling roller also serving as the base station, in order to reduce variation in the degree of close contact of the tape to the surface of cooling roller, experienced every time a tape of different type is fed. This approach, however, cannot avoid variation in film thickness resulting from long/short time of vapor deposition, mottling or surface scratches, as the speed of base material varies dependent of the increase/decrease of outer diameter of wound base material on the roller at the take-up portion.

Further, in order to lessen the damage to the base material and the thin film caused by variations in tension exerted on the base material or variations in the degree of contact between the material and the roller, derived from stretch of the base material or generation of a gas from the surface, Japanese Patent Laying-Open No. 61-264514 proposes an easing method of providing a dancer roller between the rollers. This approach, however, may have a problem that the tape tends to slip, or smooth feeding of the tape becomes difficult when frictional force F between the tape and the cooling roller also serving as the base station becomes smaller than the tensile force T₂ in the feeding direction on the recovery side take-up portion or smaller than the tensile force T₁ in the direction opposite to the feeding direction of the supply side.

Further, in order to adjust tension on the base body on the take-up side to lessen generation of wrinkles of the wound-up tape, Japanese Patent Laying-Open No. 61-278032 proposes a method of arranging a plurality of guide roller pairs on the recovery side, to have tension gradient on the tape therebetween in the direction of feeding kept at 10 N/mm² or lower. This approach is also expected to have the same problem as posed in Japanese Patent Laying-Open No. 61-264514.

### SUMMARY OF THE INVENTION

An object of the present invention is to address these conventional problems and to provide a mechanism for feeding a base material realizing highly accurate physical or chemical processing continuously on an elongate base material while the elongate base material is fed continuously, particularly such a mechanism for reducing thickness variation along the lengthwise direction or surface scratches at portions of the processed base material to which a function is added, as well as to provide a processing apparatus and thin film forming apparatus using the mechanism and the elongate member produced thereby.

The present invention provides a feeding mechanism for continuously processing an elongate base material, having a base station to which the elongate base material is fed continuously to be physically or chemically processed at a prescribed speed and from which the base material processed here is continuously recovered, wherein tensile force T₁ in a direction opposite to the feeding direction is applied at the supply side of the base station, frictional force F is applied at the base station and tensile force T₂ in the feeding direction is applied at the recovery side of the base station, on the base material, to satisfy the relation of F>T₁>T₂.

Further, the present invention provides a feeding mechanism in which, within the above-described scope, the tensile force T₁ on the supply side and the tensile force T₂ on the take-up side are adjusted in a complementary manner to constant values, while supply side torque and take-up side torque are changed in accordance with a change in difference in amount of the base material on the supply side and the recovery side. The present invention further encompasses, within the above-described scope, a mechanism in which the base material is fed while it is in contact with a roller controlled by supply side and recovery side torque motors and a roller controlled by a servo-motor at the base station.

Further, the present invention also encompasses a processing apparatus using any of the above-described feeding mechanisms, particularly a thin film forming apparatus, as well as an elongate member of which thickness variation in the lengthwise direction of the surface layer formed over the entire length of the elongate member is in the range of ±10% of the average value.

According to the present invention, when the elongate base material is fed continuously and a specific function is added to the base material at a base station on the route of feeding, it can be fed easily at a constant speed while not excessive but appropriate tensile force is applied to the base material. Therefore, it is possible to obtain a member having a function added, with few damage and superior dimensional accuracy (with small variation) along the lengthwise direction of the base material. The effect is particularly significant when the invention is applied to a thin or fine material having small cross-sectional area. By way of example, when a semiconductor layer is to be vapor-deposited on a tape having the thickness of 10 μm, a layer of about 1 μm can be formed with thickness variation along the entire length direction adjusted to be within ±10%.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows the feeding mechanism in accordance with Embodiment 1 of the present invention.

FIGS. 2A and 2B show an example of the present invention and a comparative example representing correlation between the distance and speed of feeding the base material in accordance with Embodiment 1 of the present invention.

FIG. 3 schematically shows an example of continuous monitoring means for forming the outer diameter of wound base material, in the feeding mechanism in accordance with the present invention.

FIG. 4 illustrates the concept of the feeding mechanism in accordance with an embodiment of the present invention, with guide rollers and the like omitted.

FIG. 5 is a schematic perspective view showing an elongate member having a surface layer of thin film formed over the entire length while it is fed continuously along the lengthwise direction, by the feeding mechanism in accordance with an embodiment of the present invention.

### DESCRIPTION OF THE PREFERRED EMBODIMENTS

The present invention relates to a feeding mechanism having a base station to which an elongate base material is fed continuously to be physically or chemically processed at a prescribed speed and from which the processed base material is continuously recovered, wherein tensile force T₁ in a direction opposite to the feeding direction is applied at the supply side of the base station, frictional force F is applied at the base station and tensile force T₂ in the feeding direction is applied at the recovery side of the base station, on the base material, to satisfy the relation of F>T₁>T₂.

Here, it is necessary to compare the levels of tensile forces T₁ and T₂ applied to the base material and the frictional force F at the base station, and to select the base material and processing conditions not causing excessive load on the base material and not causing any trouble in adding the function at the base station. By way of example, when soft material such as copper foil, fragile material such as paper, or a thin or fine material having small cross-sectional area along the feeding direction is selected as the base material, it is necessary to appropriately adjust the outer diameter and rotation speed of each roller and magnitude of tensile forces T₁ and T₂ to be applied to the base material, in accordance with the processing capacity of the base station and the desired process time.

The base station is on route of the feeding mechanism, where physical or chemical process is performed. As described above, at this base station, the quality altering process to add a specific function to the surface of the base material is performed, the surface of the base material is covered with a specific functional material, or the material is shaped in a prescribed shape along the feeding direction. This portion is also relayed by feeding members such as rollers, as in the above-described thin film forming apparatuses. At this portion, as the tension is applied to the base material that is being fed, friction occurs by sliding contact with the feeding member or the counterpart for adding the function.

In the feeding mechanism of the present invention, the base material receives tensile force T₁ in a direction opposite to the feeding direction on the supply side, and receives tensile force T₂ in the feeding direction on the recovery side, respectively, of the base station. By appropriately determining the tensile forces on the supply side and the recovery side in a range that satisfies the relation of F>T₁>T₂, not imposing excessive load on the base material and appropriate for the frictional force at the base station, feeding at a constant speed adequate for the desired process time becomes possible at the base station. Therefore, even when tensile forces T₁ and T₂ vary within this range because of the decrease in the amount of base material on the supply side and the increase in the amount of base material on the recovery side, the actual speed of feeding the base material is not influenced.

In the feeding mechanism in accordance with the present invention, the base material is fed, driven by the base station. When the base station is stationary, the base material is not fed, as T₁ and T₂ are set smaller than F, though tensile forces are applied to the base material. The speed of feeding the base material can accurately be adjusted to be the same as the speed of movement of the base station, when control is done to always satisfy the relation of F>T₁>T₂.

Therefore, compared with the above-described conventional feeding mechanism having a sub-roller or a dancer roller for speed adjustment arranged in the midway, the influence of variation with time in the amount difference on the supply side and the recovery side can be suppressed, even though the number of such relaying feeding portions is small. Therefore, processed base material having small variation in functional quality level such as the dimension along the lengthwise direction, can be provided, and damage caused by sticking of the base member on the base station or caused by stretch or friction of the material resulting from excessive load can significantly be reduced. Naturally, any means may be used as the feeding member (such as a roller) and the tensile force adjusting means on the supply side, base station and recovery side.

FIG. 4 schematically shows the concept of the feeding mechanism in accordance with one embodiment of the present invention, in which guide roller and the like are omitted. Referring to FIG. 4, the feeding mechanism of the present embodiment feeds base material 1 by means of a base station roller 3 and, therefore, frictional force F is applied by base station roller 3 to base material 1. Base material 1 is fed by this frictional force.

At this time, the feed speed v3 at base station roller 3 is the same as feed speed v1 at roller 2 on the supply side and feed speed v2 at roller 4 on the recovery side. Here, assuming that frictional force F of base station roller 3 fully acts as the force for feeding base material 1, no tension generates at this time on base material 1 between supply side roller 2 and base station roller 3 and on base material 1 between recovery side roller 4 and base station roller 3.

When there is no tension applied on base material 1, it is impossible to apply frictional force F of base station roller 3 to base material 1. Therefore, in order to apply tension on base material 1 between supply side roller 2 and base station roller 3, tensile force T₁ in a direction opposite to the feeding direction is applied to base material 1, by supply side roller 2. Further, in order to apply tension on base material 1 between recovery side roller 4 and base station roller 3, tensile force T₂ in the same direction as the feeding direction is applied to base material 1 by recovery side roller 4.

Here, if the tensile force T₁ in the direction opposite to the feeding direction exceeds frictional force F, it becomes impossible to feed base material 1 by base station roller 3. Therefore, the relation of F>T₁ must be satisfied.

If the tensile force T₂ on the recovery side exceeds the tensile force T₁ on the supply side, base material 1 would be pulled to the recovery side with base station roller 3 serving as a boundary, and base material 1 would slip over base station roller 3 to the recovery side. Therefore, the relation of T₁>T₂ must be satisfied.

From the foregoing, it can be seen that base material 1 can be fed by base station roller 3 and slipping of base material 1 at base station 3 can be prevented when the relation of F>T₁>T₂ is satisfied.

The feeding mechanism of the present invention is controlled such that the speed of rotation of recovery side roller controlled by a recovery side torque motor is made higher than the speed of rotation of the base station roller at the base station when the tensile force T₁ is 0, so that the relation of F>T₁>T₂ is satisfied. If the state of T₁=0 should happen, the frictional force F generated by base station roller would not be applied to the base material. Therefore, it is necessary to quickly wind-up the base material by the recovery side roller and to apply tension to the base material, so that the base material can receive the frictional force from the base station roller. Specifically, it is necessary to adjust the speed of rotation of the recovery side roller (that is, angular velocity ω2: FIG. 4) to be higher than the speed of rotation of base station roller (angular velocity ω3: FIG. 4), to increase the speed of taking-up (speed of feeding) the base material.

As an example of the embodiment for this purpose, a method is proposed in which tensile force T₁ and tensile force T₂ are adjusted in a complementary manner to constant values by varying rotation torque of motors (for example, by varying rotation torque of feeding members such as respective rollers) in accordance with the difference in amount of base material on the supply side and on the recovery side (the amount of base material wound around the supply side roller and the recovery side roller), at least until processing at the base station is finished on the entire length of the base material. This will be described with reference to an example of roller feeding. Torque motors are mounted beforehand on supply side and recovery side rollers, change in outer diameter of the base material wound on the two rollers is detected by a sensor or the like, the information is processed, and torque control commands are sent to motors so that a constant tension runs on the base material. For instance, a method may be used in which the outer diameter of the wound base material at the time point may be monitored continuously by a CCD camera, and the image data may be converted to the amount of torque change and fed back.

In this manner, excessive load on the base material can be avoided and, in addition, by appropriately determining tensile forces T₁ and T₂ in accordance with the frictional force F at the base station, feeding at a constant speed adequate for the desired process time becomes possible at the base station. Naturally, any means may be used for the feeding members on the supply side, base station and recovery side and for the tensile force adjusting means. By way of example, various members including a roller, a belt, or a rail may be used as the feeding member.

A specific example of an embodiment of the present invention includes rollers controlled by supply side and recovery side torque motors and a roller controlled by a servo motor at the base station, and the base material is fed while it is kept in contact with the rollers. On the supply side and on the recovery side with the base station in between, rollers, on which the elongate base material is wound, are positioned. These rollers each have the rotation torque controlled by a torque motor. In order to avoid excessive load on the base material and to enable feeding of the base material at a constant speed adequate for the magnitude of frictional force F, the roller at the base station is driven by a servo motor that allows speed adjustment. Naturally, a guide roller or a pinch roller may appropriately be provided additionally on the supply side and/or recovery side, so that the base material is brought into contact with an adequate contact area with the base station roller.

The effect of the feeding mechanism in accordance with the present invention is particularly significant when a functional portion of a prescribed dimension is to be formed on a thin or fine elongate material having small cross-sectional area along the feeding direction. Particularly, it is possible to easily reduce variation in thickness, depth or change in shape along the lengthwise direction, when a thin film having the thickness of up to several hundred μm is to be formed, surface processing to such a depth is to be done or a process involving change in shape of similar dimension is to be performed. Therefore, an elongate member 10 such as shown in FIG. 5 may easily be provided on which a surface layer (for example, thin film) 11 is formed along the entire length of elongate base material 1 having the thickness of about 10 μm, with thickness variation in the range of ±10% of its average value.

In the following, the present invention will be described with reference to specific examples, while the invention is not limited to the contents below.

### EXAMPLE 1

[Formation of Si Vapor-Deposited Layer on Metal Foil Tape]

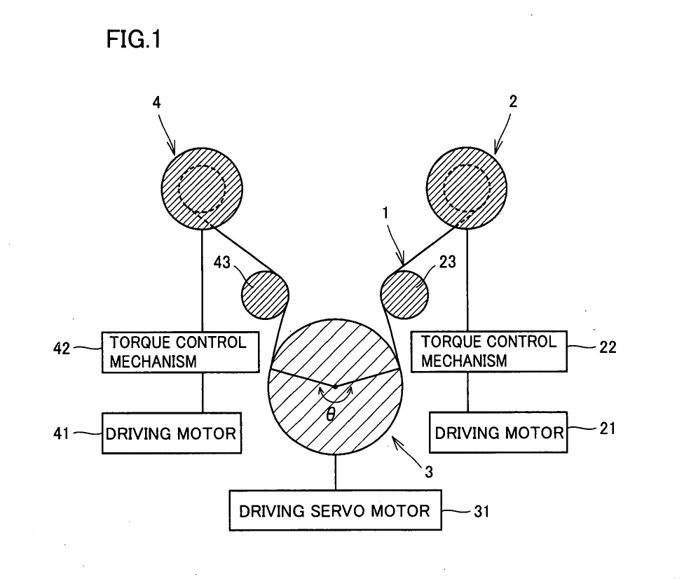

Referring to FIG. 1, base material 1 is fed from supply side roller 2, brought into contact with a guide roller 23, fed to roller 3 at the base station, brought into contact with a guide roller 43 and taken up by recovery side roller 4 and recovered. Supply side roller 2 is set to receive tensile force T₁ in the direction opposite to the feeding direction by a motor 21, for example, through an electromagnetic torque control mechanism 22, and to transmit the tensile force to base material 1. On the other hand, recovery side roller 4 is set to receive tensile force T₂ in the feeding direction by a motor 41 through an electromagnetic torque control mechanism 42, and to transmit the tensile force to base material 1.

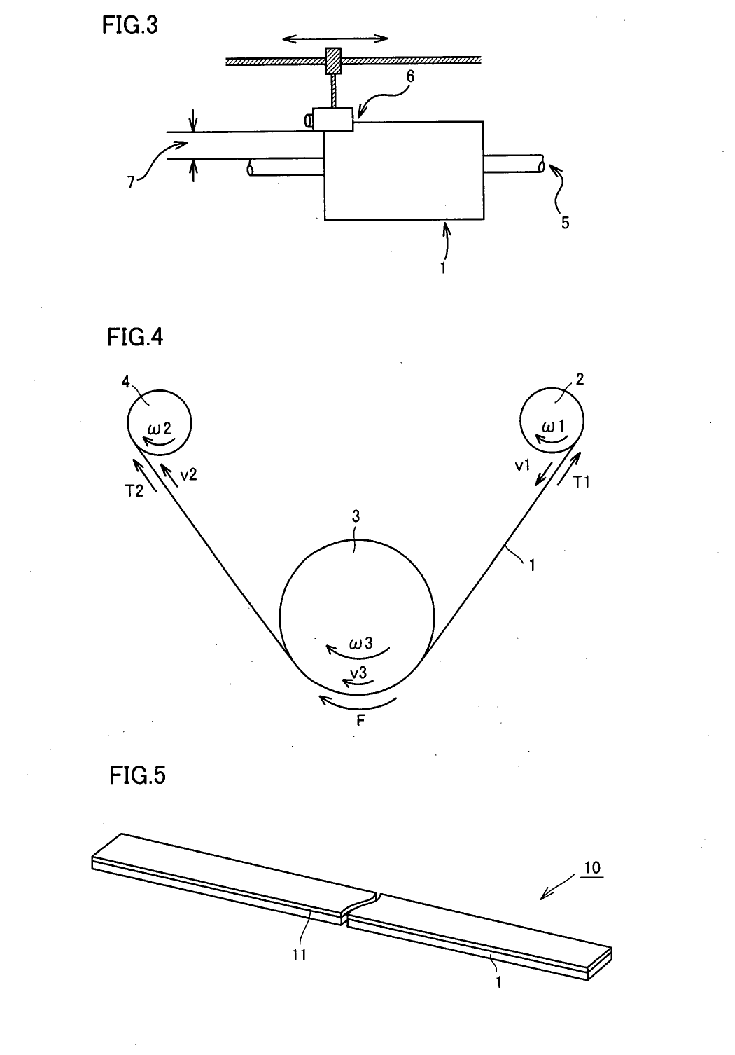

The outer diameter of the roller on which the base material is wound can be confirmed by processing an image picked up by a CCD camera as shown in FIG. 3. Referring to FIG. 3, base material 1 is wound around a roller, the roller has a core 5, and a CCD camera 6 detects outer diameter 7 of base material 1. Here, camera 6 is movable along the direction shown by an arrow in the figure. In this state, first, camera 6 moves in the radial direction to detect the outermost circumference based on contrast, then moves in the axial direction to detect the outer circumference of an exposed core bar in the similar manner, and measures the outer diameter from the difference in coordinates of the two. Torque motor output is controlled such that a product of the measured outer diameter and the torque motor output attains to a predetermined value.

Roller 3 at the processing base station shown in FIG. 1 is set to control the difference in tensions constantly in an appropriate range, by means of servo motor 31. A contact angle of base material 1 to the roller (central angle corresponding to the outer circumference where the base material 1 is in sliding contact with the roller, indicated by θ in the figure) is determined by adjusting the distance between shafts of guide rollers 23 and 24.

Using a vapor deposition apparatus having such a feeding mechanism, a silicon (Si) layer having the average thickness of 5 μm was formed on a copper foil tape as the base material having the width of 130 mm and thickness of 10 μm. Vapor deposition was done on a copper roller (cooling roller) containing coolant provided at the base station. The two guide rollers are arranged such that the contact angle θ of the tape to the roller becomes approximately 220°. Based on the contact area of the base material estimated from the contact angle, coefficient of friction between the base material and the roller confirmed beforehand by an experiment and the supply side and recovery side tensions, friction load of 300 g between the base material and the roller was confirmed. This represents the load of the level that does not cause any damage to the base material resulting from stretch of the base material itself.

Until feeding of the entire length ends, the outer diameter of the wound base material continuously decreases on the supply side and continuously increases on the recovery side, and therefore, compensation with time is necessary to lessen variation in quality of the vapor-deposited layer. It is also necessary to determine appropriate range of roller rotation speed in view of cooling capacity of the roller, minimum necessary time of vapor deposition and tolerable range of friction load not excessive to the base material. From the foregoing, the speed of rotation of the recovery side roller was estimated in advance such that it was higher than the speed of rotation of the base station roller when T₁=0, additionally taking into account the tension control level by the torque motors and the servo motor, and a feeding program was prepared.

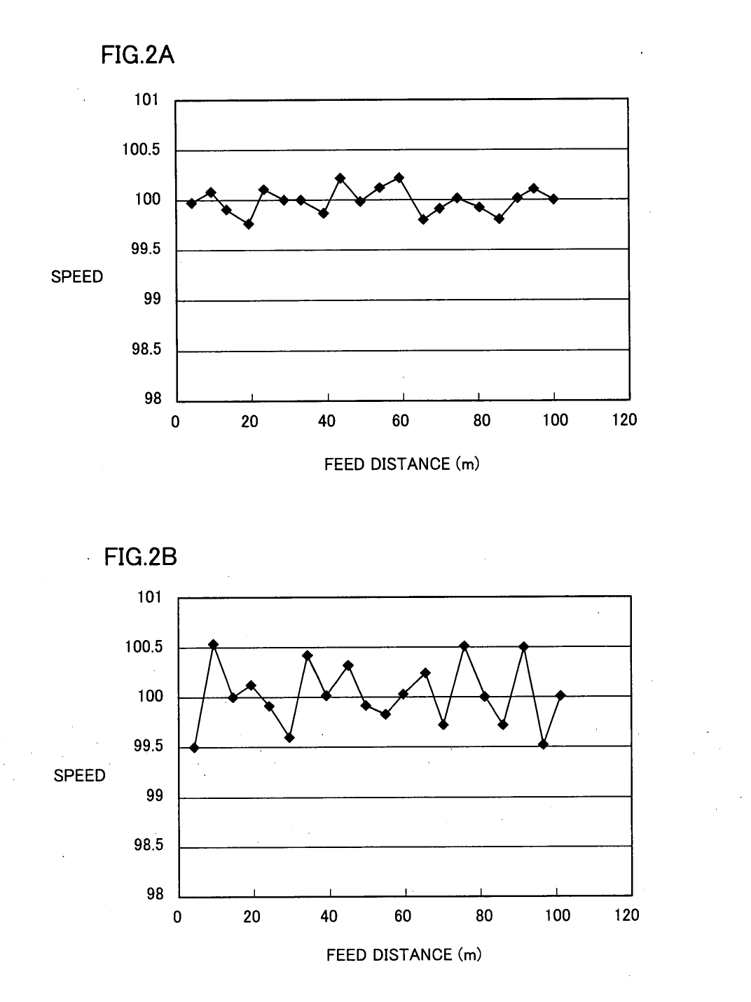

As a result, the speed of rotation of the roller at the vapor deposition base station was set to 0.2 RPM (rotations per minutes, equivalent to feeding speed of 100 m/min), tensile forces corresponding to T₁ and T₂ were set to 168 g (initial) to 210 g (final) for the former, and 125 g (initial) to 100 g (final) for the latter, respectively. In this manner, a layer having average thickness at 20 points of 5 μm, with its variation being ±0.4 μm (0.4 μm in standard deviation, ±8% as a ratio relative to the average thickness) was formed over the length of 100 m of the base material. The base material and the formed layer were free of any scratch caused by sticking or stretch. As to the tape feeding speed, a detection roller was brought into contact with the base material surface on the recovery side, feeding distance was measured by an attached rotary encoder, and with an operation of a timer, the speed was intermittently confirmed. The results are as shown in FIG. 2A.

For comparison, vapor deposition was conducted under the same conditions as above, except that the control mechanism based on the servo motor of the roller at the vapor deposition base station was omitted. As to the tape feeding speed, the speed at a detecting position on the recovery side mentioned above was kept constant using the torque control mechanism on the recovery side, by transmitting a recovery signal from the recovery side to the recovery side roller. The results are as shown in FIG. 2B. As can be seen from these results, variation in speed of the comparative example shown in FIG. 2B is twice as much as in the example of the present invention shown in FIG. 2A. From the result of comparison, it was found that in the comparative example, tensile force difference ΔT (that is, T₁−T₂) applied in the feeding direction was sometimes 0 when the speed was low, in the comparative example. Further, in the similar manner as in the example of the present invention, variation in thickness along the lengthwise direction was confirmed. In the comparative example, the average value was confirmed to be 5 μm, and its variation was confirmed to be ±1.3 μm (in standard deviation, ≅26% as a ratio relative to the average thickness). When feeding proceeded to the final stage, a point of maximum speed and a point of minimum speed appeared. At the point of maximum speed, a dent (stretch of the base material) exceeding the variation was observed on the surface of the layer, and at the point of minimum speed, slight scratch was observed on the surface.

### EXAMPLE 2

[Formation of a Magnetic Layer on Resin Tape]

Using the same feeding mechanism and similar setting program as in Example 1, a tape of polyester having the width of 400 mm and the thickness of 20 μm was fed, and a layer of cobalt-nickel magnetic alloy (chemical composition: cobalt 85 mass %, nickel 15 mass %) having average thickness of 0.1 μm was formed over 100 m. The speed of rotation of the roller at the vapor deposition base station was set to the constant speed of approximately 0.04 RPM (rotations per minutes, equivalent to feeding speed of 20 mm/min), the friction load was set to approximately 30 kg, and the tensile load on the base material near the roller on the supply side was gradually increased and the tensile load on the recovery side was gradually decreased, so that the tensile load difference was set to about 10 kg, and continuous vapor deposition was conducted. As a result, a magnetic layer of which thickness variation over the entire length was ±6% to the average value of 0.1 μm was obtained. There was no damage observed on the surface. For comparison, a vapor deposition layer was formed while the speed was adjusted simply by torque control on the recovery side, with the servo mechanism of the base station roller omitted, as in the example of copper foil described above. Then, the thickness variation was third times as large, and scratches and other damage were observed in places.

### EXAMPLE 3

[Formation of Alumite on Rail of Aluminum Alloy]

A rail-shaped base material of Al—Mg—Si based alloy having a square bracket shape (with the outer bottom side having the thickness of 1 mm and width of 3 mm, and raised portions having the thickness of 1 mm and the height of 1.5 mm, formed perpendicular to the bottom side on opposite sides) was prepared. On the entire outer bottom surface, an anode oxide layer having an average depth of 10 μm was formed over the entire length of 100 m. Portions other than the bottom surface of the base material was masked beforehand with resin. The base material was wound around a rotational winding roller on the supply side, with a spacer interposed at every turn. Tensile load of 7 kg in the direction opposite to the feeding direction was applied by a torque control motor to the winding portion, and similarly, tensile load of 4 kg in the feeding direction was applied to the winding portion of the same type on the recovery side, with an anode oxidizing apparatus positioned in between. To the base material, the force exceeding the difference of 3 kg was applied by the friction with the roller for oxidation process, and the base material was fed continuously. The feeding program described above was set such that feeding to the recovery side is done even if T₁ attains to T₁=0. The base material fed from the supply side to the anode oxidizing bath was first brought into contact, from an inlet, with two stages of oxidizing rollers having servo control mechanism, subjected to washing and drying at the third stage and fourth stage rollers, respectively, and then discharged from an outlet. Thereafter, the material was taken up by the winding portion on the recovery side. The total friction load at the oxidizing bath was 10 kg. During the process, the tensile load was adjusted to increase gradually on the supply side and to decrease gradually on the recovery side.

Variation in depth of the oxide layer formed through the process described above was confirmed along the entire length, using samples taken at equally spaced 20 sections, by oxygen line analysis of the cross-section with a scanning electron microscope. As a result, variation was ±0.6 μm (±6%) with respect to the average value of 10 μm. No damage was observed on the surface over the entire length.

By using the feeding mechanism in accordance with the present invention, when an elongate base material is fed continuously and a specific function is added to the base material at a base station on route, it is possible to obtain a member having the function added to its surface, with few damage and superior dimensional accuracy (with small variation) along the lengthwise direction of the base material. The effect is particularly significant in feeding a thin or fine material having small cross-sectional area.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A feeding mechanism, having a base station to which an elongate base material is continuously fed to be physically or chemically processed at a prescribed speed and from which the processed base material is continuously recovered, wherein tensile force T₁ in a direction opposite to a feeding direction is applied at a supply side of the base station, frictional force F is applied at the base station and tensile force T₂ in the feeding direction is applied at the recovery side of the base station, on said base material, with these forces satisfying the relation of F>T₁>T₂.

2. The feeding mechanism according to claim 1, wherein
said tensile forces T₁ and T₂ are adjusted in a complementary manner to constant values in accordance with a change in difference of an amount of said base material on said supply side and on said recovery side, at least until said process is finished over the entire length of said base material.

3. The feeding mechanism according to claim 1, wherein
said base material is fed in contact with rollers controlled by torque motors on said supply side and said recovery side and a roller controlled by a servo motor at said base station in between.

4. The feeding mechanism according to claim 1, wherein
the relation of F>T₁>T₂ is realized by setting speed of rotation of a roller on the recovery side controlled by a torque motor on said recovery side higher than speed of rotation of a base station roller at said base station when said tensile force T₁ is 0.

5. A processing apparatus using the feeding mechanism according to claim 1.

6. A thin film forming apparatus using the feeding mechanism according to claim 1.

7. An elongate member having a surface layer formed over entire length of an elongate base material, with variation in thickness of the surface layer along lengthwise direction being within ±10% of its average value.

8. The elongate member according to claim 7, wherein
said surface layer is a thin film.
